(19) United States
(12) Patent Application Publication
(10) Pub. No.: US 2022/0179609 A1
(43) Pub. Date: Jun. 9, 2022

(54) INTERACTION METHOD, APPARATUS AND DEVICE AND STORAGE MEDIUM

(71) Applicant: Beijing Sensetime Technology Development Co., Ltd., Beijing (CN)

(72) Inventors: Zilong ZHANG, Beijing (CN); Lin SUN, Beijing (CN); Qing LUAN, Beijing (CN)

(21) Appl. No.: 17/681,026

(22) Filed: Feb. 25, 2022

Related U.S. Application Data
(63) Continuation of application No. PCT/CN2020/104466, filed on Jul. 24, 2020.

(30) Foreign Application Priority Data
Aug. 28, 2019 (CN) 201910803899.3

(51) Int. Cl. G06F 3/14; G06V 40/10; G06T 7/73; G06V 10/75; G06T 7/246; G06F 3/01

(52) U.S. Cl. CPC G06F 3/14; G06V 40/10; G06T 7/73; G06T 2207/30196; G06T 7/246; G06F 3/011; G06V 10/751

(57) ABSTRACT

Methods, apparatuses, devices, and computer-readable storage media for interactions between interactive objects and users are provided. In one aspect, a computer-implemented method includes: obtaining an image of a surrounding of a display device that displays an interactive object through a transparent display screen, detecting one or more users in the image, in response to determining that at least two users in the image are detected, selecting a target user from the at least two users according to feature information of the at least two users, and driving the interactive object displayed on the transparent display screen of the display device to respond to the target user based on a detection result of the target user.

### CROSS REFERENCE TO RELATED APPLICATIONS

The present application is a continuation of international application no. PCT/CN2020/104466, filed on Jul. 24, 2020, which claims a priority of the Chinese patent application no. 201910803899.3 filed on Aug. 28, 2019, all of which are incorporated herein by reference in their entireties.

### TECHNICAL FIELD

The present disclosure relates to the field of computer vision technology, and in particular to an interaction method, apparatus and device and storage medium.

### BACKGROUND

Human-computer interaction is mostly implemented by a user input based on keys, touches, and voices, and by a respond with an image, text or a virtual human on a screen of a device. Currently, a virtual human is mostly developed on the basis of voice assistants, and the output is only generated based on a piece of voices input from the device, and the interaction between the user and the virtual human remains superficial.

### SUMMARY

The embodiments of the present disclosure provide a solution of interactions between interactive objects (e.g., virtual humans) and users.

In a first aspect, a computer-implemented method for interactions between interactive objects and users is provided, the computer-implemented method includes: obtaining an image, acquired by a camera, of a surrounding of a display device that displays an interactive object through a transparent display screen; detecting one or more users in the image; in response to determining that at least two users in the image are detected, selecting a target user from the at least two users according to feature information of the at least two users; and driving the interactive object displayed on the transparent display screen of the display device to respond to the target user based on a detection result of the target user.

By performing user detection on the image of the surrounding of the display device, and selecting the target user according to the feature information of the user, the interactive object displayed on the transparent display screen of the display device is driven to respond to the target user, so that a target user suitable for the current scenario can be selected for interaction, and the interaction efficiency and service experience are improved.

In an example, the feature information includes at least one of user posture information or user attribute information.

In an example, selecting the target user from the at least two users according to the feature information of the at least two users includes: selecting the target user from the at least two users according to at least one of a posture matching degree between the user posture information of each of the at least two users and a preset posture feature or an attribute matching degree between the user attribute information of each of the at least two users and a preset attribute feature.

By selecting a target user from multiple users according to the feature information such as user posture information and user attribute information of each user, an user suitable for the current application scenario can be selected as the target user for interaction, so as to improve the interaction efficiency and service experience.

In an example, selecting a target user from the at least two users according to the feature information of the detected at least two users includes: selecting one or more first users matching a preset posture feature according to the user posture information of each of the at least two users; in response to determining that there are at least two first users, driving the interactive object to guide the at least two first users to output preset information respectively and determining the target user according to an order in which the at least two first users respectively output the preset information.

By guiding the first user to output the preset information, a target user with high willingness to interact can be selected from users who match the preset posture feature, which can improve interaction efficiency and service experience.

In an example, selecting the target user from the at least two users according to the feature information of the at least two users includes: selecting one or more first users matching a preset posture feature according to the user posture information of each of the at least two users; in response to determining that there are at least two first users, determining an interaction response priority for each of the at least two first users according to the user attribute information of each of the at least two first users, and determining the target user according to the interaction response priority.

By combining the user attribute information, the user posture information, and application scenarios, the target user is selected from multiple detected users. By setting different interaction response priority, corresponding services for the target user are provided, so that suitable user as the target user for interaction is selected, which improves the interaction efficiency and service experience.

In an example, the method further includes: after the target user is selected from the at least two users, driving the interactive object to output confirmation information to the target user. After the target user is selected from the at least two users, driving the interactive object to output confirmation information to the target user.

By outputting confirmation information to the target user, the user can realized that the user is currently in an interactive state, and the interaction efficiency is improved.

In an example, the method further includes: in response to determining that no user is detected in the image at a current time, and no user is detected and tracked in the image within a preset time period before the current time, determining that an user to be interacted with the interactive object is empty, and driving the display device to enter a waiting for user state.

In an example, the method further includes: in response to determining that no user is detected in the image at a current time, and an user is detected and tracked in the image within a preset time period before the current time, determining that at least one user to be interacted with the interactive object is the user who interacted with the interactive object most recently.

In a case where there is no user interacting with the interactive object, by determining that the device is currently in the waiting for user state or the user leaving state, and driving the interactive object to make different responses, the display state of the interactive object is more complied with the interaction needs and more targeted.

In an example, the display device displays a reflection of the interactive object through the transparent display screen or on a base plate.

By displaying the stereoscopic image on the transparent display screen, and forming a reflection on the transparent display screen or the base plate to achieve the stereoscopic effect, the displayed interactive object is more stereoscopic and vivid.

In an example, the interactive object includes a virtual human with a stereoscopic effect.

By using the virtual human with a stereoscopic effect to interact with the users, the interaction process can be made more natural and the interaction experience of the user can be improved.

In a second aspect, an interaction device is provided, the interaction device includes: at least one processor; and one or more memories coupled to the at least one processor and storing programming instructions for execution by the at least one processor to perform the interaction method of any of the embodiments of the present disclosure.

In a third aspect, a non-transitory computer-readable medium is provided, the non-transitory computer-readable medium has machine-executable instructions stored thereon that, when executed by at least one processor, cause the at least one processor to perform the method of any of the embodiments of the present disclosure.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more embodiments of the present disclosure are set forth in the accompanying drawings and the description below. Other features and advantages of this specification will be apparent from the description and drawings, and from the claims.

### BRIEF DESCRIPTION OF THE DRAWINGS

FIG. 1 is a flowchart illustrating an interaction method according to at least one embodiment of the present disclosure.

FIG. 2 is a schematic diagram illustrating interactive object according to at least one embodiment of the present disclosure.

FIG. 3 is a schematic structural diagram illustrating an interaction apparatus according to at least one embodiment of the present disclosure.

FIG. 4 is a schematic structural diagram illustrating an interaction device according to at least one embodiment of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The term “and/or” in the present disclosure is merely an association relationship for describing associated objects, and indicates that there may be three relationships, for example, A and/or B may indicate that there are three cases: A alone, both A and B, and B alone. In addition, the term “at least one” herein means any one or any combination of at least two of the multiple, for example, including at least one of A, B, and C, and may be any one or more elements selected in the set formed by A, B and C.

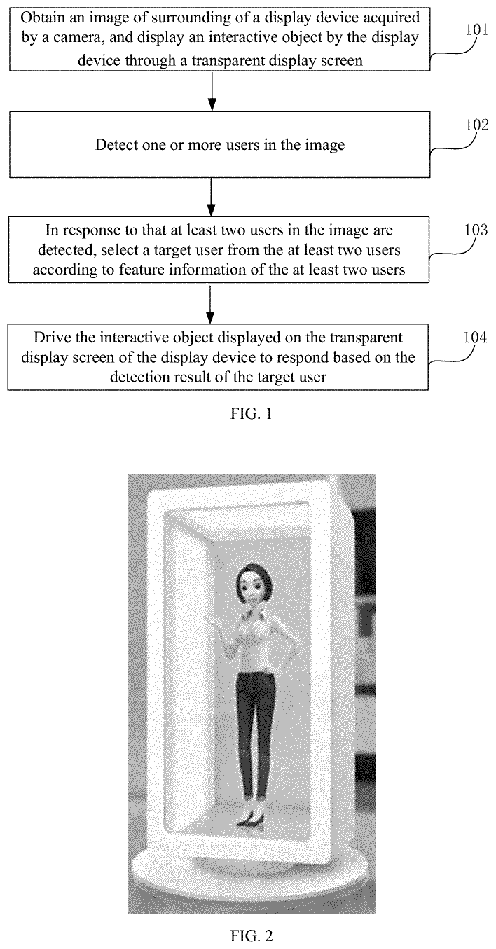

FIG. 1 is a flowchart illustrating an interaction method according to at least one embodiment of the present disclosure. As shown in FIG. 1, the method includes steps 101 to 104.

At step 101, an image of surrounding of a display device acquired by a camera is obtained, and an interactive object is displayed by the display device through a transparent display screen.

The surrounding of the display device includes any direction within a preset range of the display device, for example, the surrounding may include one or more of a front direction, a side direction, a rear direction, or an upper direction of the display device.

The camera for acquiring images can be installed on the display device or used as an external device which is independent from the display device. The image acquired by the camera can be displayed on the transparent display screen of the display device. The cameras may be plural in number.

Optionally, the image acquired by the camera may be a frame in a video stream, or may be an image acquired in real time.

At step 102, one or more users in the image are detected. The one or more users in the image described herein refer to one or more objects in the detection process of the image. In the present disclosure herein, the terms “object” and “user” can be used interchangeably, and for ease of presentation, they are collectively referred to as “user”.

By detecting users in the image of the surrounding of the display device, a detection result is obtained, such as whether there are users around the display device and a number of the users. In addition, information of the detected users can also be obtained, for example, by image recognition technology, feature information can be obtained by searching on the display device or the cloud according to the face and/or body image of the user. Those skilled in the art should understand that the detection result may also include other information.

At step 103, in response to determining that at least two users in the image are detected, a target user is selected from the at least two users according to feature information of the at least two users;

For different application scenarios, users can be selected according to corresponding feature information.

At step 104, the interactive object displayed on the transparent display screen of the display device is driven to respond based on the detection result of the target user.

In response to detection results of different target users, the interactive object can be driven to respond correspondingly to the different target users.

In the embodiments of the present disclosure, the display device is driven by performing user detection on the image of the surrounding of the display device, and selecting the target user according to the feature information of the user, the interactive object displayed on the transparent display screen is driven to respond to the target user, so that a target user suitable for the current scenario can be selected for interaction, which improves the interaction efficiency and service experience.

In some embodiments, the interactive object displayed on the transparent display screen of the display device include a virtual human with a stereoscopic effect.

By using the virtual human with a stereoscopic effect to interact with users, the interaction is more natural and the interaction experience of the user can be improved.

Those skilled in the art should understand that the interactive object is not limited to the virtual human with a stereoscopic effect, but may also be a virtual animal, a virtual item, a cartoon character, and other virtual images capable of realizing interaction functions.

In some embodiments, the stereoscopic effect of the interactive object displayed on the transparent display screen can be realized by the following method.

Whether the human eye sees an object is stereoscopic is usually determined by the shape of the object itself and the light and shadow effects of the object. The light and shadow effects are, for example, highlight and dark light in different areas of the object, and the projection of light on the ground after the object is irradiated (that is, reflection).

Using the above principles, in an example, when the stereoscopic video or image of the interactive object is displayed on the transparent display screen, the reflection of the interactive object is also displayed on the transparent display screen, so that the human eye can observe the interactive object with a stereoscopic effect.

In another example, a base plate is provided under the transparent display screen, and the transparent display is perpendicular or inclined to the base plate. While the transparent display screen displays the stereoscopic video or image of the interactive object, the reflection of the interactive object is displayed on the base plate, so that the human eye can observe the interactive object with a stereoscopic effect.

In some embodiments, the display device further includes a housing, and the front side of the housing is configured to be transparent, for example, by materials such as glass or plastic. Through the front side of the housing, the image on the transparent display screen and the reflection of the image on the transparent display screen or the base plate can be seen, so that the human eye can observe the interactive object with the stereoscopic effect, as shown in FIG. 2.

In some embodiments, one or more light sources are also provided in the housing to provide light for the transparent display screen to form a reflection.

In the embodiments of the present disclosure, the stereoscopic video or the image of the interactive object is displayed on the transparent display screen, and the reflection of the interactive object is formed on the transparent display screen or the base plate to achieve the stereoscopic effect, so that the displayed interactive object is more stereoscopic and vivid, thereby the interaction experience of the user is improved.

In some embodiments, the feature information includes user posture information and/or user attribute information, and the target user can be selected from at least two users detected in the image according to the user posture information and/or user attribute information.

The user posture information refers to feature information obtained by performing image recognition on an image, such as an action or a gesture of the user, and so on. The user attribute information relates to the feature information of the user, including an identity (for example, whether the user is a VIP user) of the user, a service record, arrival time at the current location, and so on. The feature information may be obtained from user history records stored on the display device or the cloud, and the user history records may be obtained by searching for records matching with the feature information of the face and/or body of the user on the display device or the cloud.

In some embodiments, the target user can be selected from the at least two users according to a posture matching degree between the user posture information of each of the at least two users and a preset posture feature.

For example, the preset posture feature is a hand-raising action, by matching the user posture information of the at least two users with the hand-raising action, the user with the highest posture matching degree among matching results of the at least two users can be determined as the target user.

In some embodiments, the target user can be selected from the at least two users according to an attribute matching degree between the user attribute information of each of the at least two users and a preset attribute feature.

For example, the preset attribute feature is: a VIP user and female, by matching the user attribute information of the at least two users with the preset attribute feature, the user with the highest attribute matching degree among matching results of the at least two users can be determined as the target user.

In the embodiments of the present disclosure, by selecting a target user from the at least two users detected in the image according to the feature information such as the user posture information and the user attribute information of each user. A user adapted to the current application scenario can be selected as the target user for interaction, so as to improve the interaction efficiency and service experience.

In some embodiments, the target user can be selected from the at least two users in the following manner:

First, a first user matching a preset posture feature is selected according to the user posture information of the at least two users. Matching the preset posture feature means that the posture matching degree between the user posture information and the preset posture feature is greater than a preset value, for example, greater than 80%.

For example, the posture feature is a hand-raising action, first of all, a first user whose posture matching degree between the user posture information and the hand-raising action is higher than 80% (the user is considered to have performed the hand-raising action) is selected, that is, all users who have performed the hand-raising action are selected.

In the case that there are at least two first users, the target user may be further determined by the following method: driving the interactive object to guide the at least two first users to output preset information respectively, and determining the target user according to an order of the detected first users outputting the preset information.

In an example, the preset information output by a first user may be one or more of actions, expressions, or voices. For example, at least two first users are guided to perform a jumping action, and the first user who performs the jumping action first is determined as the target user.

In the embodiments of the present disclosure, by guiding the first user to output the preset information, a target user with high willingness to interact can be selected from users who match the preset posture feature, which can improve interaction efficiency and service experience.

In the case where there are at least two first users, the target user can be further determined by the following methods:

In the case where there are at least two first users, an interaction response priority of each of the at least two first users is determined according to the user attribute information of each of the at least two first users; and the target user is determined according to the interaction response priority.

For example, if there is more than one first user who performs the hand-raising action, the interaction response priority among the first users is determined according to the user attribute information of each of the first users, and the first user with the highest priority is determined as the target user. As the selection basis, the user attribute information can be comprehensively determined in combination with current needs of a user and actual scenarios. For example, in a scenario of queuing to buy tickets, the time of arrival at the current location can be used as the basis of user attribute information to determine the interaction priority. The user who arrives first has the highest interaction response priority and can be determined as the target user. At other service locations, the target user can also be determined based on other user attribute information, for example, an interaction priority is determined based on points of the user in the location, so that the user with the highest points has the highest interaction response priority.

In an example, after the interaction response priority of each of the at least two first users is determined, each user may be further guided to output the preset information. If the number of first users who output the preset information is still more than one, the user with the highest interaction response priority can be determined as the target user.

In the embodiments of the present disclosure, the target user is selected from multiple users detected in the image in combination with the user attribute information, the user posture information, and application scenarios. By setting different interaction response priorities to provide corresponding services to the target users, a user adapted to interaction can be selected as the target user, and such that the interaction efficiency and service experience are improved.

After a user is determined as the target user for interaction, the user can be notified by outputting confirmation information. For example, the interactive object may be driven to point to the user with a finger, or the interactive object may be driven to highlight the user in a camera preview screen, or output confirmation information in other ways.

In the embodiments of the present disclosure, by outputting confirmation information to the target user, the user can clearly know that he or she is currently in an interactive state, and the interaction efficiency is improved.

After a user is selected as the target user for interaction, the interactive object only responds or preferentially responds to the instruction of the target user until the target user leaves the shooting range of the camera.

When no user is detected in the image of the surrounding of the device, it means that there is no user around the display device, that is, the device is not currently in a state of interacting with user. This state includes a state in which there is no user interacting with the device in a preset time period before the current time, that is, a waiting for user state, and also includes a state in which the user has completed the interaction in a preset time period before the current time, that is, the display device is in a user leaving state. For these two different states, the interactive object should be driven to make different responses. For example, for the waiting for user state, the interactive object can be driven to make a response of welcoming the user in combination with the current environment; and for the user leaving state, the interactive object can be driven to make a response of ending the interaction of the last user who has completed the interaction.

In some embodiments, in response to determining that no user is detected in the image at a current time and no user is tracked in the image within a preset time period of before the current time, for example, within 5 seconds, the user to be interacted with the interactive object is determined to be empty, and the interactive object on the display device is driven to enter the waiting for user state.

In some embodiments, in response to determining that no user is detected in the image at the current time, and a user is detected or tracked in the image within a preset time period before the current time, the user to be interacted with the interactive object is determined to be the user who interacted most recently.

In the embodiments of the present disclosure, in a case where there is no user interacting with the interactive object, by determining that the device is currently in the waiting for user state or the user leaving state, and driving the interactive object to make different responses, the display state of the interactive object is more complied with the interaction needs and more targeted.

In some embodiments, the detection result may include a current service state of the display device. In addition to a waiting for user state, a user leaving state, the current service state also includes a user detected state, etc. Those skilled in the art should understand that the current service state of the device may also include other states, and is not limited to the above.

In the case where the face and/or the body is detected from the image of the surrounding of the device, it means that there is a user around the display device, and the state at the moment when the user is detected can be determined as the user detected state.

In the user detected state, for the detected user, historical information of the user stored in the display device can also be obtained, and/or the historical information of the user stored in the cloud can be obtained to determine whether the user is a regular customer, or whether he/she is a VIP customer. The user historical information may also include a name, gender, age, service record, remark of the user. The user historical information may include information input by the user, and may also include information recorded by the display device and/or cloud. By obtaining the historical information of the user, the interactive object can be driven to respond to the user in a more targeted way.

In an example, the historical information matching the user may be searched according to the detected feature information of at least one of the face or body of the user.

When the display device is in the user detected state, the interactive object can be driven to respond according to the current service state of the display device, the user feature information obtained from the image, and the user historical information obtained by searching. When a user is detected for the first time, historical information of the user may be empty, that is, the interactive object is driven according to the current service state, the user feature information, and the environment information.

In the case that a user is detected in the image of the surrounding of the display device, the face and/or body of the user can be detected through the image first to obtain user feature information of the user. For example, the user is a female and the age of the user is between 20 and 30 years old; then, according to the face and/or body feature information, the historical operation information of the user is searched in the display device and/or the cloud, for example, a name of the user, a service record of the user, etc. After the user is detected, the interactive object is driven to make a targeted welcoming action to the female user, and to show the female user services that can be provided for the female user. According to the services previously used by the user included in the historical operation information of the user, the order of providing services can be adjusted, so that the user can find the service of interest more quickly.

When at least two users are detected in images of the surrounding of the device, feature information of the at least two users can be obtained first, and the feature information can include at least one of user posture information or user attribute information, and the feature information corresponds to user historical operation information, where the user posture information can be obtained by recognizing the action of the user in the image.

Next, a target user among the at least two users is determined according to the obtained feature information of the at least two users. The feature information of each user can be comprehensively evaluated in combination with the actual scene to determine the target user.

After the target user is determined, the interactive object displayed on the transparent display screen of the display device can be driven to respond to the target user.

In some embodiments, when the user is detected, after driving the interactive object to respond, by tracking the user detected in the image of the surrounding of the display device, for example, tracking the facial expression of the user, and/or, tracking the action of the user, etc., and determining whether to make the display device enter the service activated state by determining whether the user has an active interaction expression and/or action.

In an example, in the process of tracking the user, designated trigger information can be set, such as common facial expressions and/or actions for greetings, such as blinking, nodding, waving, raising hands, and slaps. In order to distinguish from the following, the designated trigger information herein may be referred to as first trigger information. When the first trigger information output by the user is detected, it is determined that the display device has entered the service activated state, and the interactive object is driven to display the service matching the first trigger information, for example, through voice or through text information of the screen.

The current common somatosensory interaction requires the user to raise his hand for a period of time to activate the service. After selecting a service, the user needs to keep his hand still for several seconds to complete the activation. In the interaction method provided by the embodiments of the present disclosure, the user does not need to raise his hand for a period of time to activate the service, and does not need to keep the hand still to complete the selection. By automatically determining the designated trigger information of the user, the service can be automatically activated, so that the device is in the service activated state, thereby the user is avoided from raising his hand and waiting for a period of time, and the user experience is improved.

In some embodiments, in the service activation state, designated trigger information can be set, such as a specific gesture, and/or a specific voice command. In order to distinguish the designated trigger information from the above, the designated trigger information herein may be referred to as second trigger information. When the second trigger information output by the user is detected, it is determined that the display device has entered the in-service state, and the interactive object is driven to display a service matching the second trigger information.

In an example, the corresponding service is executed through the second trigger information output by the user. For example, the service that can be provided to the user include: a first service option, a second service option, a third service option, etc., and corresponding second trigger information can be configured for the first service option, for example, the voice “one” can be set for the second trigger information corresponding to the first service option, the voice “two” can be set for the second trigger information corresponding to the second service option, and so on. When it is detected that the user outputs one of the voices, the display device enters the service option corresponding to the second trigger information, and the interactive object is driven to provide the service according to the content set by the service option.

In the embodiment of the present disclosure, after the display device enters the user detected state, two granular of recognition methods are provided. When the first trigger information output by the user is detected, the first-granular (coarse-grained) recognition method is to enable the device to enter the service activated state, and drive the interactive object to display the service matching the first trigger information. When the second trigger information output by the user is detected, the second-granular (fine-grained) recognition method is to enable the device to enter the in-service state, and drive the interactive object to provide the corresponding service. Through the above two granular of recognition methods, interactions between the user and the interactive object can be smoother and more natural.

Through the interaction method provided by the embodiments of the present disclosure, the user does not need to enter keys, touches, or input voices. The user just needs to stand by the display device, the interactive object displayed on the display device can make a targeted welcome action and follow an instruction from the user, and display services can be provided according to the needs or interests of the user, thereby the user experience is improved.

In some embodiments, the environmental information of the display device may be obtained, and the interactive object displayed on the transparent display screen of the display device can be driven to respond according to a detection result and the environmental information.

The environmental information of the display device may be obtained through a geographic location of the display device and/or an application scenario of the display device. The environmental information may be, for example, the geographic location of the display device, an internet protocol (IP) address, or the weather, date, etc. of the area where the display device is located. Those skilled in the art should understand that the above environmental information is only an example, and other environmental information may also be included.

For example, when the display device is in the waiting for user state and the user leaving state, the interactive object may be driven to respond according to the current service state and the environment information of the display device. For example, when the display device is in the waiting for user state, the environmental information includes time, location, and weather condition, the interactive object displayed on the display device can be driven to make a welcome action and gesture, or make some interesting actions, and output the voice “it's XX o'clock, X (month) X (day), X (year), weather is XX, welcome to XX shopping mall in XX city, I am glad to serve you”. In addition to the general welcome actions, gestures, and voices, the current time, location, and weather condition are also added, which not only provides more information, but also makes the response of interactive objects more complied with interaction needs and more targeted.

By performing user detection on the image of the surrounding of the display device, the interactive object displayed in the display device is driven to respond according to the detection result and the environmental information of the display device, so that the response of the interactive object is more complied with the interaction needs, and the interaction between the user and the interactive object is more real and vivid, thereby the user experience is improved.

In some embodiments, a matching and preset response label may be obtained according to the detection result and the environmental information; then, the interactive object is driven to make a corresponding response according to the response label. This application is not limited to the above.

The response label may correspond to the driving text of one or more of the action, expression, gesture, or voice of the interactive object. For different detection results and environmental information, corresponding driving text can be obtained according to the response label, so that the interactive object can be driven to output one or more of a corresponding action, an expression, or a voice.

For example, if the current service state is the waiting for user state, and the environment information indicates that the location is Shanghai, the corresponding response label may be that the action is a welcome action, and the voice is “Welcome to Shanghai”.

For another example, if the current service state is the user detected state, the environment information indicates that the time is morning, the user attribute information indicates a female, and the user historical record indicates that the last name is Zhang, the corresponding response label can be: the action is welcome, the voice is “Good morning, madam Zhang, welcome, and I am glad to serve you”.

By configuring corresponding response labels for the combination of different detection results and different environmental information, and using the response labels to drive the interactive object to output one or more of the corresponding actions, expressions, and voices, the interactive object can be driven according to different states of the device and different scenarios to make different responses, so that the responses from the interactive object are more diversified.

In some embodiments, the response label may be input to a trained neural network, and the driving text corresponding to the response label may be output, so as to drive the interactive object to output one or more of the corresponding actions, expressions, or voices.

The neural network may be trained by a sample response label set, wherein the sample response label is annotated with corresponding driving text. After the neural network is trained, the neural network can output corresponding driving text for the output response label, so as to drive the interactive object to output one or more of the corresponding actions, expressions, or voices. Compared with directly searching for the corresponding driving text on the display device or the cloud, the trained neural network can be used to generate the driving text for the response label without a preset driving text, so as to drive the interactive object to make an appropriate response.

In some embodiments, for high-frequency and important scenarios, it can also be optimized through manual configuration. That is, for a combination of the detection result and the environmental information with a higher frequency, the driving text can be manually configured for the corresponding response label. When the scenario appears, the corresponding driving text is automatically called to drive the interactive object to respond, so that the actions and expressions of the interactive object are more natural.

In one embodiment, in response to the display device being in the user detected state, according to the position of the user in the image, position information of the interactive object displayed in the transparent display screen relative to the user is obtained; and the orientation of the interactive object is adjusted according to the position information so that the interactive object faces the user.

In some embodiments, the image of the interactive object is acquired by a virtual camera. The virtual camera is a virtual software camera applied to 3D software and used to acquire images, and the interactive object is displayed on the screen through the 3D image acquired by the virtual camera. Therefore, a perspective of the user can be understood as the perspective of the virtual camera in the 3D software, which may lead to a problem that the interactive object cannot have eye contact with the user.

In order to solve the above problem, in at least one embodiment of the present disclosure, while adjusting the body orientation of the interactive object, the line of sight of the interactive object is also kept aligned with the virtual camera. Since the interactive object faces the user during the interaction process, and the line of sight remains aligned with the virtual camera, the user may have an illusion that the interactive object is looking at himself, such that the comfort of the user's interaction with the interactive object is improved.

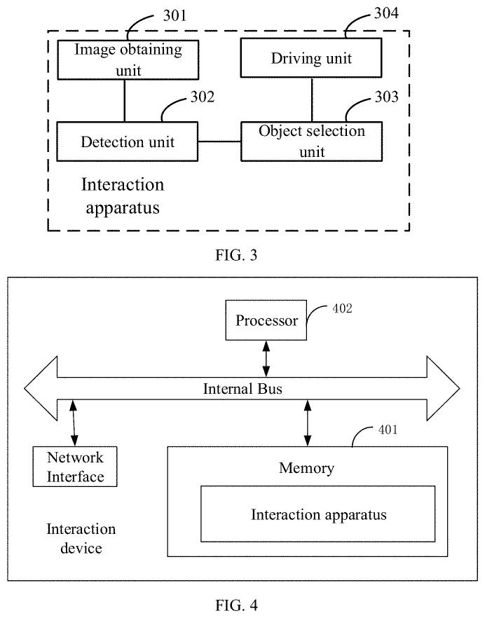

FIG. 3 is a schematic structural diagram illustrating an interaction apparatus according to at least one embodiment of the present disclosure. As shown in FIG. 3, the apparatus may include: an image obtaining unit 301, a detection unit 302, an object selection unit 303 and a driving unit 304.

The image obtaining unit 301 is configured to obtain, an image acquired by a camera, of a surrounding of a display device; wherein the display device displays an interactive object through a transparent display screen; the detection unit 302 is configured to detect one or more objects in the image; the object selection unit 303 is configured to, in response to determining that at least two objects in the image are detected, select a target object from the at least two objects according to feature information of the at least two objects; and the driving unit 304 is configured to drive the interactive object displayed on the transparent display screen of the display device to respond to the target object based on a detection result of the target object. The one or more users in the image described herein refer to one or more objects involved in the detection process of the image.

In some embodiments, the feature information includes at least one of object posture information or object attribute information.

In some embodiments, the object selection unit 303 is configured to: select the target object from the at least two objects according to a posture matching degree between the object posture information of each of the at least two objects and a preset posture feature or an attribute matching degree between the object attribute information of each of the at least two objects and a preset attribute feature.

In some embodiments, the object selection unit 303 is configured to: select one or more first objects matching a preset posture feature according to the object posture information of each of the at least two objects; when there are at least two first objects, drive the interactive object to guide the at least two first objects to output preset information respectively and determine the target object according to an order in which the at the least two first objects respectively output the preset information.

In some embodiments, the object selection unit 303 is configured to select one or more first objects matching a preset posture feature according to the object posture information of each of the at least two objects; when there are at least two first objects, determine an interaction response priority for each of the at least two first objects according to the object attribute information of each of the at least two first objects, and determine the target object according to the interaction response priority.

In some embodiments, the apparatus further includes a confirmation unit, configured to: in response to determining that the object selection unit selecting the target object from the at least two objects, drive the interactive object to output confirmation information to the target object.

In some embodiments, the apparatus further includes a waiting state unit, configured to: in response to determining that no object is detected in the image at a current time, and no object is detected and tracked in the image within a preset time period before the current time, determine that an object to be interacted with the interactive object is empty, and driving the display device to enter a waiting for object state.

In some embodiments, the apparatus further includes an ending state unit, configured to: in response to determining that no object is detected in the image at a current time, and an object is detected and tracked in the image within a preset time period before the current time, determine that an object to be interacted with the interactive object is the object who interacted with the interactive object most recently.

In some embodiments, the display device displays a reflection of the interactive object through the transparent display screen, or displays the reflection of the interactive object on a base plate.

In some embodiments, the interactive object includes a virtual human with a stereoscopic effect.

At least one embodiment of the present disclosure also provides an interaction device. As shown in FIG. 4, the device includes a memory 401 and a processor 402. The memory 401 is used to store instructions executable by the processor, and when the instructions are executed, the processor 402 is prompted to implement the interaction method described in any embodiment of the present disclosure.

At least one embodiment of the present disclosure also provides a computer-readable storage medium, having a computer program stored thereon, where when the computer program is executed by a processor, the processor implements the interaction method according to any of the foregoing embodiments of the present disclosure.

Those skilled in the art should understand that one or more embodiments of the present disclosure may be provided as a method, a system, or a computer program product. Therefore, one or more embodiments of the present disclosure may adopt the form of a complete hardware embodiment, a complete software embodiment, or an embodiment combining software and hardware. One or more embodiments of the present disclosure may take the form of a computer program product which is implemented on one or more computer-usable storage media storage media (including but not limited to disk storage, CD-ROM, optical storage, etc.) including computer-usable program codes.

The various embodiments in the present disclosure are described in a progressive manner, and the same or similar parts between the various embodiments can be referred to each other, and each embodiment focuses on the differences from other embodiments. In particular, since the apparatus embodiments are basically similar to the method embodiments, the description is relatively simple, and for related parts, please refer to the description of the method embodiments.

The specific embodiments of the present disclosure have been described above. Other embodiments are within the scope of the appended claims. In some cases, the actions or steps described in the claims can be performed in a different order than in the embodiments and still achieve desired results. In addition, the processes depicted in the drawings do not necessarily require the specific order or sequential order shown in order to achieve the desired results. In some embodiments, multitasking and parallel processing are also possible or may be advantageous.

The embodiments of the subject and functional operation in the present disclosure can be implemented in the following: a digital electronic circuit, a tangible computer software or firmware, a computer hardware including the structure disclosed in the present disclosure and structural equivalents thereof, or a combination of one or more of the above. Embodiments of the subject matter of the present disclosure may be implemented as one or more computer programs, i.e., one or more modules of computer program instructions encoded on a tangible non-transitory program carrier to be executed by a data processing apparatus or to control the operation of the data processing apparatus. Alternatively or additionally, program instructions may be encoded on an artificially generated propagating signal, such as a machine-generated electrical, optical or electromagnetic signal, which is generated to encode and transmit information to a suitable receiver device for execution by a data processing device. The computer storage medium may be a machine-readable storage device, a machine-readable storage substrate, a random or serial access memory device, or a combination of one or more thereof.

The processes and logic flows in the present disclosure may be performed by one or more programmable computers executing one or more computer programs to perform corresponding functions by operating in accordance with input data and generating an output. The processing and logic flows may also be performed by dedicated logic circuitry, such as FPGA (Field Programmable Gate Array) or ASIC (Application Specific Integrated Circuit), and the apparatus may also be implemented as dedicated logic circuitry.

Computers suitable for executing computer programs include, for example, general purpose and/or special purpose microprocessors, or any other type of central processing unit. Typically, the central processing unit will receive instructions and data from read only memory and/or random access memory. The basic components of the computer include a central processing unit for implementing or executing instructions and one or more memory devices for storing instructions and data. Typically, the computer will also include one or more mass storage devices for storing data, such as magnetic disks, magneto-optical disks or optical disks, or the like, or the computer will be operatively coupled with such mass storage devices to receive data therefrom or to transfer data thereto, or both. However, a computer does not necessarily have such a device. Furthermore, a computer may be embedded in another device, such as a mobile phone, a personal digital assistant (PDA), a mobile audio or video player, a game console, a global positioning system (GPS) receiver, or a portable storage device such as a universal serial bus (USB) flash drive, to name a few.

Computer readable media suitable for storing computer program instructions and data include all forms of non-volatile memory, media, and memory devices, including, for example, semiconductor memory devices (e. g., EPROM, EEPROM, and flash memory devices), magnetic disks (e. g., internal hard disks or removable disks), magneto-optical disks, and CD ROM and DVD-ROM disks. The processor and memory may be supplemented by or incorporated into a dedicated logic circuit.

While this disclosure includes numerous specific implementation details, these should not be construed as limiting the scope of the disclosure or the claimed scope, but are primarily used to describe features of some embodiments of the disclosure. Certain features of various embodiments of the present disclosure may also be implemented in combination in a single embodiment. On the other hand, various features in a single embodiment may also be implemented separately in multiple embodiments or in any suitable sub-combination. Moreover, while features may function in certain combinations as described above and even initially so claimed, one or more features from the claimed combination may in some cases be removed from the combination, and the claimed combination may point to a variation of the sub-combination or alternative of the sub-combination.

Similarly, although operations are depicted in a particular order in the figures, this should not be construed as requiring these operations to be performed in the particular order shown or in order, or requiring all of the illustrated operations to be performed to achieve the desired result. In some cases, multitasking and parallel processing may be advantageous. Moreover, the separation of various system modules and components in the above embodiments should not be construed as requiring such separation in all embodiments, and it should be understood that the described program components and systems may generally be integrated together in a single software product or encapsulated into multiple software products.

Thus, specific embodiments of the subject matter have been described. Other embodiments are within the scope of the appended claims. In some cases, the acts described in the claims may be performed in different orders and still achieve the desired results. Moreover, the processes depicted in the figures are not necessarily the particular order or order shown to achieve the desired results. In some implementations, multitasking and parallel processing may be advantageous.

The foregoing is merely some embodiments of the present disclosure, and is not intended to limit the present disclosure. Any modifications, equivalent replacements, improvements, etc. made within the spirit and principle of the present disclosure should be included within the scope of the present disclosure.

1. A computer-implemented method for interactions between interactive objects and users, the computer-implemented method comprising:
obtaining an image of a surrounding of a display device, wherein the display device displays an interactive object through a transparent display screen;
detecting one or more users in the image;
in response to determining that at least two users in the image are detected, selecting a target user from the at least two users according to feature information of the at least two users; and
driving the interactive object displayed on the transparent display screen of the display device to respond to the target user based on a detection result of the target user.

2. The computer-implemented method of claim 1, wherein the feature information comprises at least one of user posture information or user attribute information.

3. The computer-implemented method of claim 2, wherein selecting the target user from the at least two users according to the feature information of the at least two users comprises:
selecting the target user from the at least two users according to at least one of
a posture matching degree between the user posture information of each of the at least two users and a preset posture feature or
an attribute matching degree between the user attribute information of each of the at least two users and a preset attribute feature.

4. The computer-implemented method of claim 2, wherein selecting the target user from the at least two users according to the feature information of the at least two users comprises:
selecting one or more first users matching a preset posture feature according to the user posture information of each of the at least two users;
in response to determining that there are at least two first users, driving the interactive object to guide the at least two first users to respectively output preset information; and
determining the target user according to an order in which the at least two first users respectively output the preset information.

5. The computer-implemented method of claim 2, wherein selecting the target user from the at least two users according to the feature information of the at least two users comprises:
selecting one or more first users matching a preset posture feature according to the user posture information of each of the at least two users;
in response to determining that there are at least two first users, determining an interaction response priority for each of the at least two first users according to the user attribute information of each of the at least two first users; and
determining the target user according to the interaction response priority.

6. The computer-implemented method of claim 1, further comprising:
after the target user is selected from the at least two users, driving the interactive object to output confirmation information to the target user.

7. The computer-implemented method of claim 1, further comprising:
in response to determining that no user is detected in the image at a current time, and no user is detected and tracked in the image within a preset time period before the current time, determining that a user to be interacted with the interactive object is empty, and driving the display device to enter a waiting for user state.

8. The computer-implemented method of claim 1, further comprising:
in response to determining that no user is detected in the image at a current time, and at least one user is detected and tracked in the image within a preset time period before the current time, determining that a user to be interacted with the interactive object is a user who interacted with the interactive object most recently.

9. The computer-implemented method of claim 1, wherein the display device displays a reflection of the interactive object through the transparent display screen or on a base plate.

10. The computer-implemented method of claim 1, wherein the interactive object comprises a virtual human with a stereoscopic effect.

11. An interaction device, comprising:
at least one processor; and
one or more memories coupled to the at least one processor and storing programming instructions for execution by the at least one processor to perform operations for interactions between interactive objects and users, the operations comprising:
obtaining an image of a surrounding of a display device, wherein the display device displays an interactive object through a transparent display screen;
detecting one or more users in the image;
in response to determining that at least two users in the image are detected, selecting a target user from the at least two users according to feature information of the at least two users; and
driving the interactive object displayed on the transparent display screen of the display device to respond to the target user based on a detection result of the target user.

12. The interaction device of claim 11, wherein the feature information comprises at least one of user posture information or user attribute information.

13. The interaction device of claim 12, wherein selecting the target user from the at least two users according to the feature information of the at least two users comprises:
selecting the target user from the at least two users according to at least one of:
a posture matching degree between the user posture information of each of the at least two users and a preset posture feature or
an attribute matching degree between the user attribute information of each of the at least two users and a preset attribute feature.

14. The interaction device of claim 12, wherein selecting the target user from the at least two users according to the feature information of the at least two users comprises:
selecting one or more first users matching a preset posture feature according to the user posture information of each of the at least two users;
in response to determining that there are at least two first users, driving the interactive object to guide the at least two first users to respectively output preset information; and
determining the target user according to an order in which the at least two first users respectively output the preset information.

15. The interaction device of claim 12, wherein selecting the target user from the at least two users according to the feature information of the at least two users comprises:
selecting one or more first users matching a preset posture feature according to the user posture information of each of the at least two users;
in response to determining that there are at least two first users, determining an interaction response priority for each of the at least two first users according to the user attribute information of each of the at least two first users; and
determining the target user according to the interaction response priority.

16. The interaction device of claim 11, the operations further comprising:
after the target user is selected from the at least two users, driving the interactive object to output confirmation information to the target user.

17. The interaction device of claim 11, the operations further comprising:
in response to determining that no user is detected in the image at a current time and that no user is detected and tracked in the image within a preset time period before the current time, determining that a user to be interacted with the interactive object is empty, and driving the display device to enter a waiting for user state.

18. The interaction device of claim 11, the operations further comprising:
in response to determining that no user is detected in the image at a current time, and at least one user is detected and tracked in the image within a preset time period before the current time, determining that a user to be interacted with the interactive object is a user who interacted with the interactive object most recently.

19. The interaction device of claim 11, wherein the display device displays a reflection of the interactive object through the transparent display screen or on a base plate.

20. A non-transitory computer-readable storage medium having machine-executable instructions stored thereon that, when executed by at least one processor, cause the at least one processor to perform operations for interactions between interactive objects and users, the operations comprising:
obtaining an image of a surrounding of a display device, wherein the display device displays an interactive object through a transparent display screen;
detecting one or more users in the image;
in response to determining that at least two users in the image are detected, selecting a target user from the at least two users according to feature information of the at least two users; and
driving the interactive object displayed on the transparent display screen of the display device to respond to the target user based on a detection result of the target user.
